(19) United States
(12) Patent Application Publication
(10) Pub. No.: US 2011/0067643 A1
(43) Pub. Date: Mar. 24, 2011

(54) Air vent tube for aquarium and fish tanks special usage and strengthen

(76) Inventor: Zhengyi Wu, Chatsworth, CA (US)

(21) Appl. No.: 11/901,318

(22) Filed: Sep. 18, 2007

(51) Int. Cl. A01K 63/04

(52) U.S. Cl. 119/263

(57) ABSTRACT

I am Wu Zheng Yi, have invented AIR VENT TUBE FOR AQUARIUM AND FISH TANKS SPECIAL USEGE AND STRENGTHEN (Air Vent tube). This invention, Air Vent Tube (AVT), is for aquarium products and fish tanks using and strengthen. This Air Vent Tube is the best suitable for aquariums and fish tanks to increase air and oxygen in the water in fish tank, because fishes in the fish tanks need more oxygen in the water. The structure of Air Vent Tube is the idea created at least two surfaces and three surfaces, which are formed right angle shape and triangle shape. There is a long hole in the Air Vent Tube and the long hole connects with the short outflow hole in the large surface of the Air Vent tube. Along the Air Vent Tube length extension and view as long shape. These invented AVT can be made of glass material or other materials.

I, Zheng Yi Wu, have invented a new AIR VENT TUBE for fish tanks and aquariums using and strengthen. as set forth in the following specification. The claimed AIR VENT TUBE is using for fish tanks and aquarium to add more air in the fish tanks and aquarium. The AIR VENT TUBE is using for fish tanks and aquarium to increase fresh air and oxygen into the water in fish tank and aquarium.

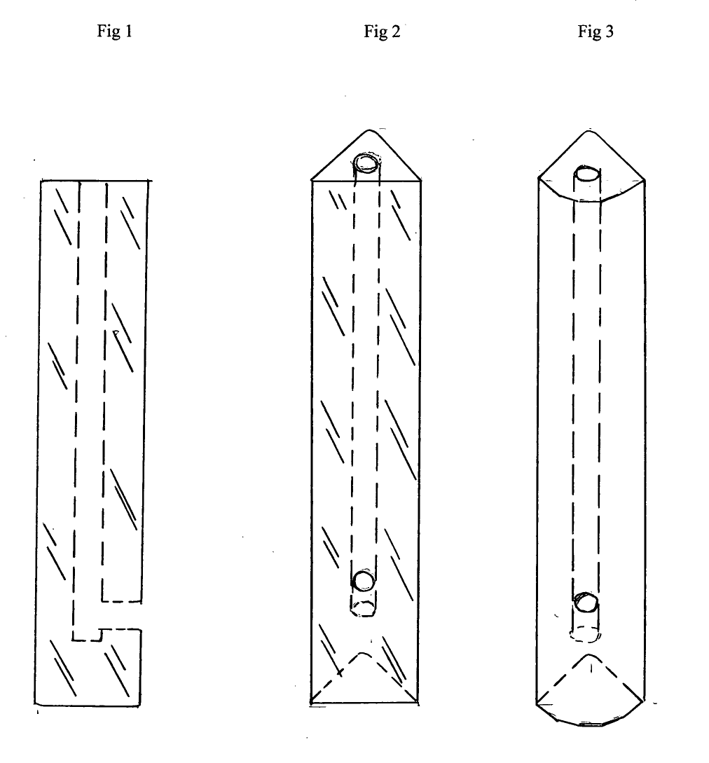

FIG. 1 is the body of AIR VENT TUBE view a long shape with long hole inside and there are a flow-in hole and a flow-out hole. It will make of glass or other materials.

FIG. 2 is a right triangle long shape AIR VENT TUBE view of its design structure.

FIG. 3 is a right angle multi edges fan-shape AIR VENT TUBE view of its design and structure.

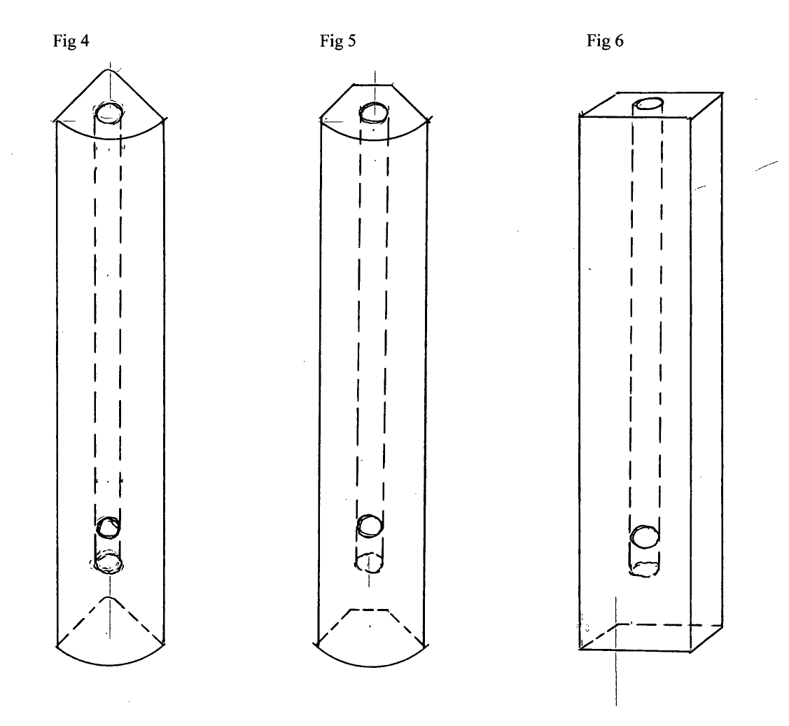

FIG. 4 is a right angle fan-shape AIR VENT TUBE view of its design and structure.

FIG. 5 is a cut right angle fan-shape AIR VENT TUBE view of its design and inside structure.

FIG. 6 is a four equal sides four right angles long-shape AIR VENT TUBE view of its design and structure.

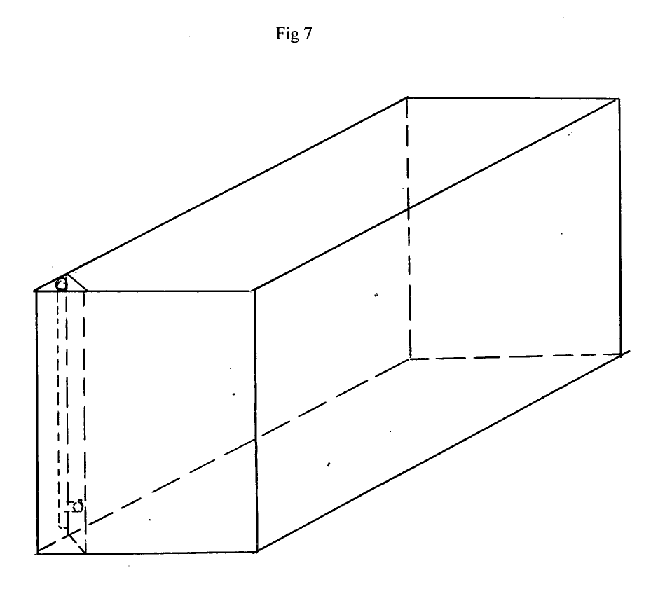

FIG. 7 is right triangle AIR VENT TUBE has been pre-installed in the corner of a fish tank view of the AIR VENT TUBE installed in the fish tank to increase fresh air and oxygen into the water in the fish tank.

FIG. 1 is the structure and vertical cut section view of the Air Vent Tube showing long hole and short hole connecting and my invention and design for aquarium and fish tanks usage and strengthen. (1—Air Vent Tube body made of glass or transparent material. 2—long hole and 3—short hole connects with long hole for air flowing)

I claim: the new invented Air Vent Tube is for aquarium and fish tanks special usage and strengthens as shown.

I, Wu Zheng Yi, have invented the air Vent Tube for aquarium and fish tanks special usage and strengthen, as set forth in the flowing specification. The claimed the right triangle Air Vent Tube is used for aquarium and fish tank special usage for add more air, oxygen and make the fish tanks look beauty and clean in the water and strengthen aquarium and fish tank to be stronger and solid.

FIG. 2 is a right triangle long shape aquarium Air Vent Tube including over view and top section view. The FIG. 2 shows 1—body of the Air Vent Tube, 2—the long hole of the Air Vent Tube, 3—is short hole for air and oxygen out going. 4—is the top view of the right triangle Air Vent Tube.

I claim: the right triangle long shape Air Vent Tube is invented for aquarium and fish tanks special usage and strengthen as shown.

I, Wu Zheng Yi, have invented the Air Vent Tube for aquarium and fish tanks special usage and strengthen, as set forth in the following specification. The claimed right angle multiple Edges and faces fan-shape Air Vent Tube is for aquarium and fish tank special usage for add more air, oxygen and make the fish tanks look beauty and clean in the water and strengthen aquarium and fish tank to be stronger and solid.

FIG. 3 is right angle multi faces long, fan-shape section Air Vent Tube including over view and top section view. The FIG. 3 shows, 1—body of the Air Vent Tube, 2—the long hole of the Air Vent Tube, 3—is short hole for air and oxygen out going. 4—is the top view of the right triangle multi edges and faces Air Vent Tube.

I claim: right angle multi edges and faces Air Vent Tube is invented for aquarium and fish tanks special usage and strengthen as shown.

I, Wu Zheng Yi, have invented the Air Vent Tube for aquarium and fish tanks special usage and strengthen, as set forth in the following specification. The claimed Air Vent Tube is for aquarium and fish tank special usage for add more air, oxygen and make the fish tanks look beauty and clean in the water and strengthen aquarium and fish tank to be more stronger and solid

FIG. 4 is the right angle fan-shape edge and face Air Vent Tube view including over view and top section view. The FIG. 4 shows, 1—body of the Air Vent Tube, 2—the long hole of the Air Vent Tube, 3—is short hole for air and oxygen out going and connecting with log hole 4—is the top view of the right angle edges face fang shape and faces Air Vent Tube.

I claim: right fang shape edges and faces Air Vent Tube is invented for aquarium and fish tanks special usage and strengthen.

I, Wu Zheng Yi, have invented the Air Vent Tue for aquarium and fish tanks special usage and strengthen, as set forth in the following specification. The claimed Air Vent Tube is for aquarium and fish tank special usage for add more air, oxygen and make the fish tanks look beauty and clean in the water and strengthen aquarium and fish tank to be more stronger and solid.

FIG. 5 is right angle cut long, fan-shape view of the Air Vent Tube including over view and top section view. The FIG. 5 shows, 1—body of the Air Vent Tube, 2—the long hole of the Air Vent Tube, 3—is short hole for air and oxygen out going. 4—is the top view of the right triangle cut edges and faces Air Vent Tube is invented for aquarium and fish tanks special usage and strengthen.

I claim: right angle cut long, fan-shape Air Vent Tube including over view and top section view are invented for aquarium and fish tanks special usage and strengthen.

I, Wu Zheng Yi, have invented the Air Vent Tube for aquarium and fish tanks special usage and strengthen, as set forth in the following specification The claimed Air Vent Tube is for aquarium and fish tanks special usage for add more air, oxygen and make the fish tanks look beauty and clean in the water and strengthen aquarium and fish tank to be more stronger and solid

FIG. 6 is a four right angle and square edges and faces long view and top section view of the Air Vent Tube including over view and top section view. The FIG. 6 shows, 1—body of the air Vent Tube, 2—the long hole of the Air Vent tube, 3—is a short hole for air and oxygen out going. 4—is the top view of the four right angles and faces long shape of Air Vent Tube.

I claim: four right angles, four edges and faces of the Air Vent Tube are invented for aquarium and fish tanks special usage and strengthen.

I, Wu Zheng Yi, have invented the Air Vent Tube for aquarium and fish tanks special usage and strengthen, as set forth in the following specification. The claimed Air Vent Tube is for aquarium and fish tank special usage for add more air, oxygen and make the fish tanks look beauty and clean in the water and strengthen aquarium and fish tank to be more stronger and solid.

FIG. 7 is a glass fish tank with right triangles Air Vent Tube includes and faces Air Vent Tube is designed for aquarium and fish tanks special usage and strengthen.

I claim: for the all-new shapes of the invented Air Vent Tube for aquarium and fish tanks special usage for the fish tank strengthen.

1. I claim: the new invented air vent tube is for aquarium and fish tanks special usage and strengthens as shown: I, Wu Zhengyi, have invented the air Vent Tube for aquarium and fish tanks special usage and strengthen, as set forth in the flowing specification. The claimed the right triangle Air Vent Tube is used for aquarium and fish tank special usage for add more air, oxygen and make the fish tanks look beauty and clean in the water and strengthen aquarium and fish tank to be stronger and solid.
FIG. 2 is a right triangle long shape aquarium Air Vent Tube including; over view and, section view. The FIG. 2 shows 1—body of the Air Vent Tube, 2—the long hole of the Air Vent Tube, 3—is short hole for air and oxygen out going. 4—is the top view of the right triangle Air Vent Tube.
I claim: the right triangle long shape Air Vent Tube is invented for aquarium and fish tanks special usage and strengthen as shown.
I, Wu Zhengyi, have invented the Air Vent Tube for aquarium and fish tanks special usage and strengthen, as set forth in the following specification. The claimed right angle multiple Edges and faces fan-shape Air Vent Tube is for aquarium and fish tank special usage for add more air, oxygen and make the fish tanks look beauty and clean in the water and strengthen aquarium and fish tank to be stronger and solid.
FIG. 3 is right angle multi faces long, fan-shape section Air Vent. Tube including over view and top section view. The FIG. 3 shows, 1—body of the Air Vent Tube, 2—the long hole of the Air Vent Tube, 3—is short hole for air and oxygen out going. 4—is the top view of the right triangle multi edges and faces Air Vent Tube.
I claim: right angle multi edges and faces Air Vent Tube is invented for aquarium and fish tanks special usage and strengthen as shown.
I, Wu Zhengyi, have invented the Air Vent Tube for aquarium and fish tanks special usage and strengthen, as set forth in the following specification. The claimed Air Vent Tube is for aquarium and fish tank special usage for add more air, oxygen and make the fish tanks look beauty and clean in the water and strengthen aquarium and fish tank to be more stronger and solid
FIG. 4 is the right angle fan-shape edge and face Air Vent Tube view including over view and top section view. The FIG. 4 shows, 1—body of the Air Vent Tube, 2—the long hole of the Air Vent Tube, 3—is short hole for air and oxygen out going and connecting with log hole 4—is the top view of the right angle edges face fang shape and faces Air Vent Tube.
I claim: right fang shape edges and faces Air Vent Tube is invented for aquarium and fish tanks special usage and strengthen.
I, Wu Zhengyi, have invented the Air Vent Tue for aquarium and fish tanks special usage and strengthen, as set forth in the following specification. The claimed Air Vent Tube is for aquarium and fish tank special usage for add more air, oxygen and make the fish tanks look beauty and clean in the water and strengthen aquarium and fish tank to be more stronger and solid.
FIG. 5 is right angle cut long, fan-shape view of the Air Vent Tube including over view and top section view. The FIG. 5 shows, 1—body of the Air Vent Tube, 2—the long hole of the Air Vent Tube, 3—is short hole for air and oxygen out going. 4—is the top view of the right triangle cut edges and faces Air Vent Tube is invented for aquarium and fish tanks special usage and strengthen.
I, Wu Zhengyi, have invented the Air Vent Tube for aquarium and fish tanks special usage and strengthen, as set forth in the following specification The claimed Air Vent Tube is for aquarium and fish tanks special usage for add more air, oxygen and make the fish tanks look beauty and clean in the water and strengthen aquarium and fish tank to be more stronger and solid
FIG. 6 is a four right angle and square edges and faces long view and top section view of the Air Vent Tube including over view and top section view. The FIG. 6 shows, 1—body of the air Vent Tube, 2—the long hole of the Air Vent tube, 3—is a short hole for air and oxygen out going. 4—is the top view of the four right angles and faces long shape of Air Vent Tube.
I claim: four right angles, four edges and faces of the Air Vent Tube are invented for aquarium and fish tanks special usage and strengthen.
I, Wu Zhengyi, have invented the Air Vent Tube for aquarium and fish tanks special usage and strengthen, as set forth in the following specification. The claimed Air Vent Tube is for aquarium and fish tank special usage for add more air, oxygen and make the fish tanks look beauty and clean in the water and strengthen aquarium and fish tank to be more stronger and solid.
FIG. 7 is a glass fish tank with right triangles Air Vent Tube includes and faces Air Vent Tube is designed for aquarium and fish tanks special usage and strengthen.
I claim: for the all-new shapes of the invented Air Vent Tube for aquarium and fish tanks special usage for the fish tank strengthen.
